(19) United States
(12) Patent Application Publication
(10) Pub. No.: US 2003/0095151 A1
(43) Pub. Date: May 22, 2003

(54) Real-time interactive adjustment of control parameters for a genetic algorithm computer

(76) Inventors: J. Barry Shackleford, Portola Valley, CA (US); Richard J. Carter, Los Altos, CA (US)

Correspondence Address: HEWLETT-PACKARD COMPANY, Intellectual Property Administration, P.O. Box 272400, Fort Collins, CO, 80527-2400, US

(21) Appl. No.: 09/988,598

(22) Filed: Nov. 20, 2001

(51) Int. Cl. G06F 3/00

(52) U.S. Cl. 345/833

(57) ABSTRACT

A genetic algorithm machine with user-controlled parameters that is non-problem specific. A user interface directly manipulates several input parameters, the number of crossovers per run, the probability that any bit will be a cutpoint, and the probability that any bit will be mutated, that constrain the genetic algorithm machine's solving capabilities, allowing the user to control whether and how efficiently the genetic algorithm evolves a best solution.

### TECHNICAL FIELD OF THE INVENTION

The present invention relates generally to a computer system for executing software programs, particularly, to a genetic algorithm machine for executing genetic algorithms, and more particularly to a genetic algorithm machine with real-time controls in a graphical user interface that allow adjustment of certain parameters of evolution during run-time.

### BACKGROUND

Although evolutionary computing has roots as far back as the 1950s, genetic algorithms (hereinafter referred to by the initials GA) were introduced in 1975 by John Holland as a method for finding an optimum or near optimum solution to complicated problems. As noted by another researcher, Grefenstette, the GA is a useful method for finding optimum solutions to the Traveling Salesman Problem, a classic and well-known computationally intractable problem.

With reference now to FIG. 1, there is illustrated therein a conceptual model of a genetic algorithm and how a solution to a problem evolves in processing the GA, generally designated by the reference numeral 100. As is understood in this art, in a genetic algorithm, an emulated chromosomal data structure is initially designed to represent a candidate or trial solution. A number of n-bit chromosomes of that data structure are then randomly generated and are registered in groups or populations of solutions. Parent chromosomes are selected from this population of generated chromosomes according to a given algorithm, e.g., selected chromosomes 105 and 110 in FIG. 1. Each generated chromosome is assigned a unique problem-specific fitness which may or may not differ from other chromosomes in the population, identifying the solution quality of the chromosome. The problem-specific fitness is expressed by a fitness value, as is known in the art. In a true evolutionary, survival of the fittest manner, particular chromosomes are selected from the population of chromosomes in proportion to their fitness values with more-fit chromosomes having a higher probability of being selected.

As further illustrated in FIG. 1, when a pair of parent chromosomes, e.g., chromosomes 105 and 110, are selected from the population, the parent chromosomes are combined using a probabilistically generated cut point, designated by the reference numeral 120. In the case of having no cutpoint generated, either of the parent chromosomes is simply copied to provide a new chromosome as a child chromosome. Thus, a child chromosome is created and outputted. The child chromosome, therefore, contains portions of each parent or the whole portion of a parent, e.g., a child chromosome 125 contains portion 105A of parent chromosome 105 and portion 110B of parent chromosome 110, as illustrated in FIG. 1. The child chromosome may then be mutated in a controlled manner, preferably having a low probability. In the evolutionary example illustrated in FIG. 1, the mutation is performed through inversion of a bit 130 in the child chromosome 125, e.g., 0 to 1 or 1 to 0. A mutated child chromosome 125′ is then evaluated to be assigned its fitness value. An evaluated child chromosome along with its fitness value is then stored as a member of the next generation in the population, perhaps replacing one or both of the associated parent chromosomes 105 and 110.

After repeated iteration of this evolutionary process, the general fitness of chromosomes in the population improves toward the optimal solution. Thus, a solution to the problem emerges in the population, and is acquired with highly-fit chromosomes concentrated in the population.

A disadvantage of the conventional GA approach, however, is that the GA is extremely slow in its execution speed when emulated by software on a conventional general-purpose computer.

U.S. Pat. No. 5,970,487 to Shackleford, et al. solved some of the drawbacks and disadvantages of prior art genetic algorithm techniques, particularly speed of operation, by the utilization of a hardware-based framework for accelerated use of genetic algorithms. The advantages and usages of the Shackleford et al. invention, Shackleford being the sole inventor in the instant application, are fully described in U.S. Pat. No. 5,970,487, which is incorporated by reference herein.

Even though a hardware optimization may significantly speed up the performance of a genetic algorithm, it should readily be understood that hardware alone is not enough to solve many problems. Indeed, some problems may be so intractable that new paradigms of operation are required to solve them. For example, the problems of protein folding tax even the fastest computers. As is known in the art, chains of amino acids or residues make up proteins. The amino acids are, in turn, divided into hydrophobic residues which are repelled by the solvating water molecules, and hydrophilic residues which can form hydrogen bonds with water molecules. So, when a protein chain is allowed to fold and seek its lowest energy conformation, the hydrophobic residues will tend to be clustered together in the center and the hydrophilic residues will tend to be on the outside. A solution to this problem describes the complex fold patterns of the given protein. Because the protein folding problem has such a large number of possible solutions, finding a good solution using a GA machine requires approximately 40,000 or more generations of evolution.

A conventional GA machine, however, may not continue evolving a solution if a good solution requires 40,000 generations or more. Depending on several input parameters, such as crossover rate and mutation rate, a good solution may take many more generations to evolve, or if the input parameters are set incorrectly, the GA machine may never evolve a good solution. Thus, input parameters must be carefully manipulated. At present, these input parameters are revised after every run either by manually rewriting and recompiling the code or by reconfiguring the hardware.

There is, therefore, a present need for an improved technique to input and modify a variety of parameters into a genetic algorithm in a dynamic or run-time fashion, thereby avoiding or ameliorating the static consequences of many prior art techniques.

It is, accordingly, an aspect of the present invention to provide a system and methodology whereby a user can facilitate genetic algorithm evolution by dynamic or run-time adjustments to a number of evolutionary parameters, guiding the evolution through direct manipulation of the genetic algorithm as a solution evolves.

### SUMMARY

The present invention describes a system and method to increase the performance of a genetic algorithm technique through the addition of display controls that allow human input during run-time. Adjustment of certain evolution parameters reduces processing time and increases the ability of the GA machine to evolve a best solution. A graphical interface between a user and the GA machine allows the GA to run more effectively under human guidance and direct control, without waiting between each run for the parameters to be manipulated manually.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DESCRIPTION OF THE DRAWINGS

The features, aspects, and advantages of the present invention will become better understood with regard to the following description, appended claims, and accompanying drawings where:

FIG. 1 illustrates a conceptual diagram of evolution in a GA machine, such as employed in the system and methodology of the present invention;

FIG. 2 depicts a flowchart illustrating the flow of a genetic algorithm machine within which the principles of the present invention may be employed;

FIG. 3 depicts a block diagram of a crossover module and a crossover template generator for combining two parental chromosomes into a single child chromosome;

FIG. 4 depicts the effects of changing the crossover rate on the crossover template generator of FIG. 3;

FIG. 5 depicts a block diagram of a mutation module for mutating one or more bits of a child chromosome;

FIG. 6 depicts the effects of changing the mutation rate on a mutation template for the mutation module of FIG. 5;

FIG. 7 illustrates a first representative interface screen of the present invention at a first setting;

FIG. 8 illustrates a second setting;

FIG. 9 illustrates a third setting;

FIG. 10 illustrates a fourth setting;

FIG. 11 illustrates a fifth setting; and

FIG. 12 illustrates a sixth setting.

### DETAILED DESCRIPTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention. The present invention is not intended to be limited to the embodiments shown, but is to be accorded the widest possible scope consistent with the principles and features disclosed herein.

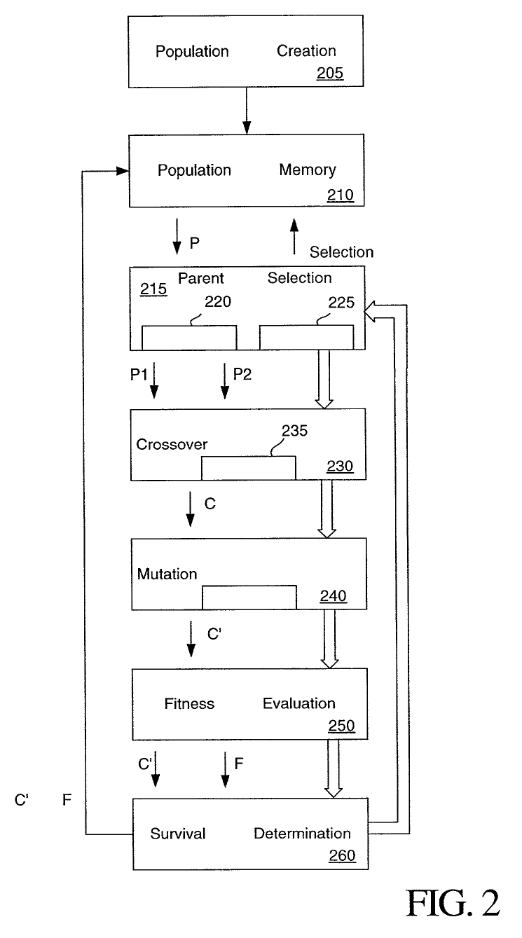

The present invention provides an improvement to previous implementations of a hardware-based GA machine, such as that set forth in Shackleford et al. To assist in the general explanation of the operation of a GA machine, reference is now made to FIG. 2, which shows a flowchart of a genetic algorithm, designated by the reference numeral 200, with parental chromosomes P1 and P2, a child chromosome C, a mutated child chromosome C′, and a fitness value F, all described in more detail hereinbelow.

As illustrated in FIG. 2, the first step is to create (step 205) a population of randomly generated chromosomes, evaluate their respective fitness values and store the chromosomes and their respective fitness values in a population memory 210.

A parent chromosome, generally designated by the reference symbol P, is then randomly selected (step 215) from the population memory 210 and loaded as the first parent chromosome P1 into a first chromosome register designated in FIG. 2 by the reference numeral 220. It should be understood that when a parent chromosome is newly selected, the parent chromosome that was previously in the first chromosome register 220 is then transferred to a second chromosome register 225. The first chromosome register 220 then receives the newly-selected parent chromosome.

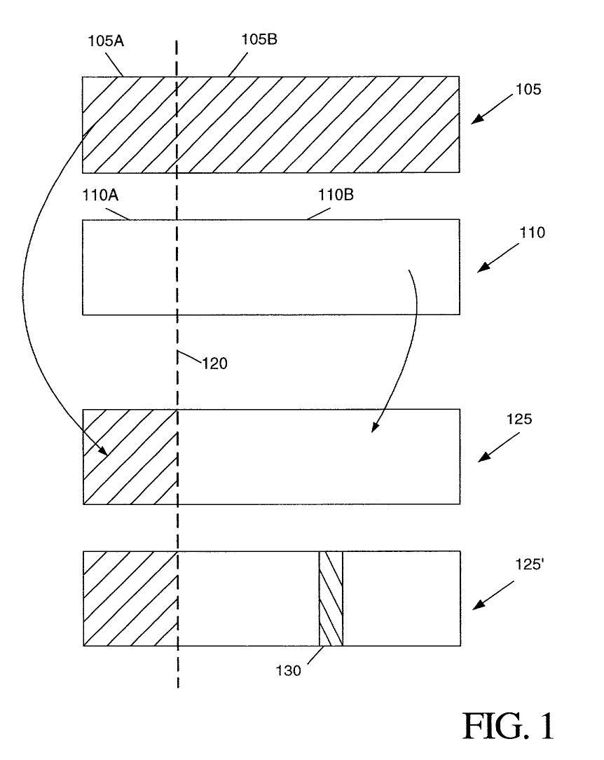

A child chromosome C is then created (step 230) from the two parent chromosomes P1 and P2 residing in the aforementioned first and second chromosome registers 220 and 225, respectively, through a crossover process, such as described above in connection with FIG. 1. In other words, the crossover process is a single-point crossover, whereby the first and second parent chromosome registers 220 and 225 are divided, each at the same bit location, and the data to the left of that location in the first parent chromosome register 220 is used to form the left part of a child chromosome C in a child chromosome register 235 and the data inclusive of the bit and to the right in the second parent chromosome register 225 is used to form the right part of the child chromosome C.

In a mutation step 240, each bit in the child chromosome C, for example, the aforedescribed bit 130 in FIG. 1, is exposed to the possibility of mutation. After one or more bits within the child chromosome register 235 are flipped (or changed using another mechanism of random-like mutation), the mutated child chromosome C′ is stored in a mutated child chromosome register 245. In a preferred embodiment of the present invention, the probability of mutation for each bit is typically on the order of 1 percent.

After mutation, an evaluation of the child chromosome C′ is made by a fitness function (step 250). A preferred fitness function is a re-configurable circuit which evaluates the problem-specific fitness of a child chromosome, as is understood in the art.

Finally, the survival of the mutated child chromosome C′ is determined (step 260) based upon the fitness value F of the child chromosome C′ outputted from the fitness function 250. For example, the fitness value F of the child chromosome C′ is compared with the least-fit fitness value of the least-fit chromosome stored in the population memory 210. If the child chromosome C′ is more fit, then the child chromosome C′ replaces the less-fit chromosome in the population memory. If, however, the child chromosome C′ is less fit, then the child chromosome C′ is simply discarded.

The repetitions of the steps of this process, i.e., 215 to 260, shown in double lines, improve the quality of candidate solutions toward an optimum solution.

It should also be understood that after repeated iteration of this process, the general fitness of chromosomes in the population improves. Thus, a solution to the problem emerges in the population. A best solution to the problem is acquired with highly-fit chromosomes concentrated in the population.

The present invention preferably utilizes a hardware-based GA machine, the methodology of which is illustrated hereinabove in FIG. 2, with the addition of a dynamic interface. In addition to improved hardware, however, there are several evolution parameters that affect the execution speed and efficiency of a GA machine used to solve problems.

With reference to the protein folding problem discussed briefly hereinabove, it is well understood in this art that a conventional GA machine requires certain parameters to be set within a range in order to evolve a good solution to the problem, and within a narrower range to evolve a good solution in an efficient number of generations. Solutions to other intractable problems have alternative ranges and preferred initial and final values, as is understood in the respective arts and in computational algorithm theory.

From an instrumentational standpoint, an interface with the user, implemented, for example, on a graphical user interface through a PC, e.g., where a GA machine is encoded onto a Personal Computer Memory Card International Association (PCMCIA) card inserted into the PC, allows certain significant evolution parameters or variables to be changed while the GA machine is running. For instance, these variables may be:

(1) the number of crossovers per run;

(2) the probability that any given bit in the chromosome will be a cutpoint for a crossover operation; and

(3) the probability that any bit in the chromosome will be mutated.

A user through a graphical user interface has the ability to directly change certain variables during real time operation of the GA. A possible method of implementing the effects of the changing the variables is described in detail below.

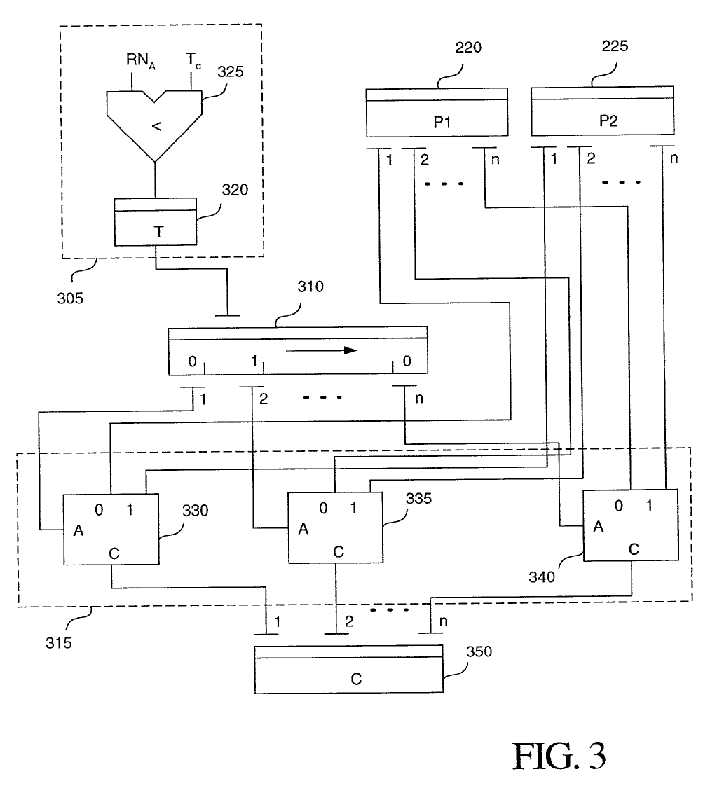

With reference now to FIG. 3 of the Drawings, there is illustrated a crossover module, generally designated by the reference numeral 300, which implements the various components employed in the aforementioned crossover step 230. The probability of crossover in the crossover module 300 can be changed, for example, by varying the cutpoint threshold T_{c}.

The crossover module 300 is the part of a GA machine that combines the two parental chromosomes to create a child chromosome, as illustrated and described above in connection with FIGS. 1 and 2. As illustrated, each bit of the generated child chromosome requires a two-input multiplexer to select between the two parents. In particular, a multiplexer aggregate is controlled by a crossover template, as generated in a crossover template generator. The crossover template is sent to all multplexers by a shift register, requiring one flip-flop per bit, but having the advantage of only needing two adjacent-bit connections.

As illustrated in FIG. 3, the crossover module 300 includes a crossover template generator 305, a crossover template shift register 310, and n multiplexers, collectively designated by the reference numeral 315. The crossover module 300 is illustrated with parental chromosomes P1 and P2 from the aforementioned parent chromosome registers 220 and 225 in FIG. 2, a child chromosome C from the child chromosome register 235, and bits P1₁ to P1ₙ in the bit string of length n of the parent chromosome P1, bits P2₁ to P2ₙ in the bit string of length n of the parent chromosome P2, and bits C₁ to Cₙ in the bit string of length n of the child chromosome C. The crossover template generator 305 generates a base serial pattern of a crossover template. The crossover template shift register 310 inputs the serial pattern, shifts the pattern bit by bit and outputs an n-bit crossover template to the aforementioned n multiplexers 315. Each of said multiplexers 315 performs a crossover operation on a parent chromosome based upon the crossover template.

As illustrated in FIG. 3, the crossover template generator 305 generates the aforementioned crossover template indicating a cutpoint to regulate the participation of the two parent chromosomes in the crossover process. This participation is regulated by supplying a serial pattern of binary digits (1s and 0s) in the crossover template to the crossover template shift register 310. A cutpoint may be represented by a 10 or 01 data pattern so that a cutpoint can be acknowledged by that pattern appearing in the serial pattern, as is understood in the art.

A cutpoint generation is performed probabilistically controlled by the following elements:

(1) an externally supplied parameter cutpoint threshold value T_{c} indicating the probability of any bit being a cutpoint, and

(2) a random number stream generated by a random number generator RN_{A}.

The serial pattern of the crossover template is preferably generated by a toggle flip-flop 320 whose input is connected to a threshold comparator 325. As illustrated in FIG. 3, a first input to the threshold comparator 325 is the cutpoint threshold value T_{c}, and a second input is a random number from the random number generator RN_{A}. As is well understood in the art, the random number generator RN_{A} generates a random number independent from all other random numbers generated by other random number generators used in the machine. In particular, the random number generator RN_{A} generates a random number in the range of 0 to rₘₐₓ. The mathematical probability p_{c} of a cutpoint at any given bit is then determined by

p_{c}=T_{c}/(rₘₐₓ+1)

where T_{c} is the cutpoint threshold value, as described above. It should be understood that the cutpoint threshold value T_{c} is controlled by the user interface.

As indicated by the “less than” symbol “<” within the threshold comparator 325, the threshold comparator output is a 1 when the random number is less than the threshold value T_{c}, which causes, in turn, the toggle flip-flop 320 to change the state of its output. Thus, the toggle flip-flop 320 outputs the pattern indicating a cutpoint into the crossover template shift register 310.

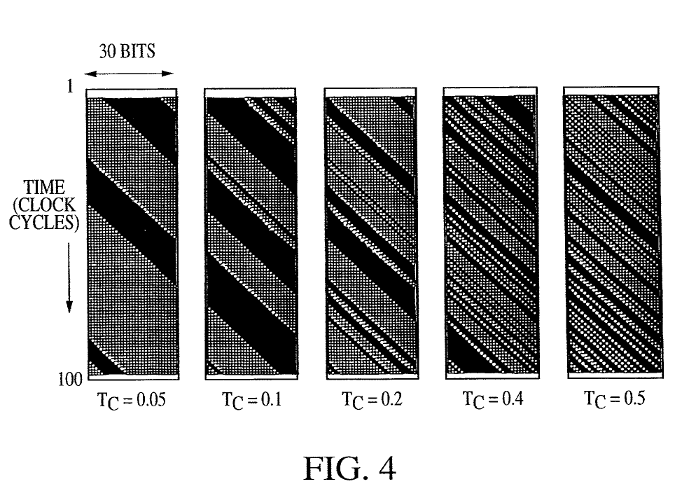

With reference now to FIG. 4, there is illustrated the effects of varying the cutpoint threshold value T_{c} on the cutpoint template. Larger values of the cutpoint threshold value T_{c} increase the number of cutpoints per chromosome on the template; likewise, smaller values of the cutpoint threshold value T_{c} decrease the number of cutpoints on the template.

The crossover module 300 is now described more in detail further with reference to FIG. 3.

The crossover template generated by the crossover template generator 305 is inputted sequentially to the crossover template shift register 310 and then subjected to a bit-by-bit shifting. A bit-based shifting operation of the crossover template can provide diversity of bit position of the cutpoint in the template, which is essential to the operation of a GA machine. As the crossover template is shifted one bit to the right in the crossover template shift register 310, a new serial pattern generated by the toggle flip-flop 320 is inputted sequentially at the left-most position of the crossover template shift register 310.

As shown in FIG. 3, the crossover module 300 includes the aforementioned multiplexer 315, n of which correspond to the respective bits in the n-bit chromosome. Each of the individual multiplexers 315, for example 330, 335 and 340, corresponding to bits 1, 2 and n of the bits in the aforementioned crossover template shift register 310, include two inputs (P1 and P2), an address (A) and an output (C). Each of the inputs and the address are either a zero or a one. In general, where address A is zero, the first input, i.e., P1, is selected and outputted to C, and where address A is one, the second input, i.e., P2, is selected and outputted to C. For example, with particular reference to multiplexer 330, the first bit stored in the crossover template shift register 310 is zero, thereby causing selection of the value P1₁, which is the corresponding bit selected from the aforementioned first parent chromosome register 220. Conversely, with particular reference to multiplexer 335, the second bit stored in the crossover template shift register 310 is a one, thereby causing selection of the value P2₂, which is the corresponding bit selected from the aforementioned second parent chromosome register 225, as described in connection with FIG. 2. As with multiplexer 330, the multiplexer 340 corresponding to the n^{th} bit causes selection of the value P1ₙ, i.e., the n^{th} bit of the first parent chromosome register 220.

The child chromosome C resulting from the crossover merger of the two aforementioned parental chromosomes P1 and P2 pursuant to the crossover template mechanism is designated in FIG. 3 by the reference numeral 350. It should also be understood that for ease of computation, the child chromosome C bit pattern is also stored in the aforementioned child chromosome register 235.

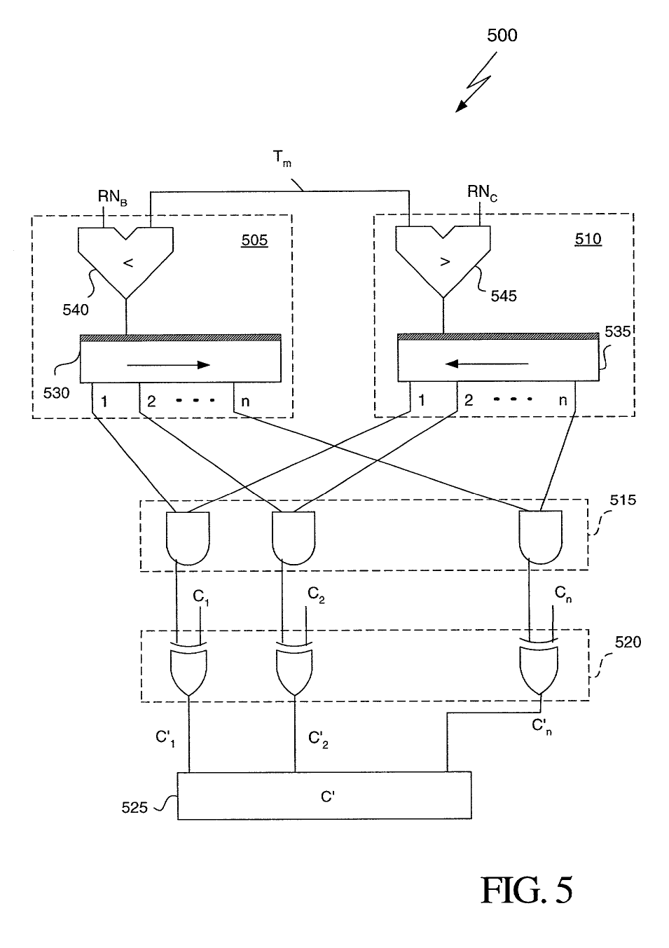

A user interface pursuant to the principles of the present invention may also have be employed in changing other variables as well. For instance, the user may change the probability of mutation in a mutation module, generally designated by the reference numeral 500 in FIG. 5, by changing a mutation threshold Tₘ. As will be illustrated further herein below, varying the mutation threshold Tₘ has the same effect as varying the cutpoint threshold T_{c}, but affects a more complicated equation.

With reference now to FIG. 5, there is illustrated a block diagram of the mutation module 500 in detail. It should, of course, be understood that the mutation module 500 shown in FIG. 5 represents a presently preferred implementation of the various components employed in the aforementioned mutation step 240. As is understood in the art, the mutation module 500 randomly and probabilistically changes the generated child chromosome to insure further genetic diversity of the total population. The mutation is preferably effected by two random number generators, generally designated by the reference symbols RN_{B}, and RN_{C}, two bit-shift registers 530 and 535, and n AND and XOR gates, collectively designated by the reference numerals 515 and 520, respectively.

As generally described in connection with FIG. 2, n bits of a child chromosome C, e.g., C₁ to Cₙ, are mutated (step 240) into a mutated child chromosome C′, e.g., C′₁ to C′ₙ, which is illustrated in FIG. 5 and generally designated by the reference numeral 525.

If the aforedescribed crossover module 300 is deemed the primary operator of a genetic algorithm, then the mutation module 500 is the secondary genetic operator. The mutation module's chief purpose is to provide genetic diversity at a given bit position. According to a preferred embodiment of the present invention, the mutation is performed on all bits in the child chromosome C independently, probabilistically and simultaneously. Mutation is performed through inversion of a bit value, i.e., a 1 changes to a 0 and a 0 changes to a 1, e.g., the aforementioned bit 130 in FIG. 1.

With further reference to FIG. 5, the mutation operator 500 includes a first mutation template generator 505, a second mutation template generator 510, the n AND gates 515, the n XOR gates 520 and the mutated child chromosome 525. The first mutation template generator 505 includes the aforementioned random number generator RN_{B}, the first shift register 530, and an absolute value comparator 540. The second mutation template generator 510 includes the aforementioned random number generator RN_{C}, the second shift register 535, and an absolute value comparator 545.

In this embodiment, a random pulse stream is generated respectively from the first and second mutation template generators 505 and 510 based upon two uncorrelated random numbers, i.e., RN_{B} and RN_{C}. The first absolute value comparator 540 receives a random number stream from the first random number generator RN_{B} as input and compares the random number stream with an externally supplied value representing the aforementioned mutation threshold value Tₘ. Likewise, the second absolute value comparator 545 receives another random number stream from the second random number generator RN_{C} as input and compares the random number stream with the mutation threshold value Tₘ.

It should be understood in this art that the mutation threshold value Tₘ represents the probability of 1s in each bit stream of 1s and 0s. For example, when the random number generator RN_{B} generates random numbers from 0 to rₘₐₓ, then the density of one values is Tₘ/(rₘₐₓ+1).

With reference again to FIG. 5, particularly the mutation template generators 505 and 510, when the random numbers are less than the mutation threshold value Tₘ, the first absolute value comparator 540, as well as the second absolute value comparator 545, output is 1. Conversely, when the random numbers are greater than the mutation threshold value Tₘ, the first and second absolute value comparators 540 and 545 output is 0. It should be understood that a bit stream of 1s and 0s from the either of the absolute value comparators 540 and 545 has a probability Tₘ/(rₘₐₓ+1) of ones in the bit stream, and the combined probability from both random number streams of a mutation pₘ at any bit is

pₘ=(Tₘ/(rₘₐₓ+1))²

It should be also be noted that the shift registers 530 and 535 shift in opposite directions to better decorrelate the random bit streams, producing a “scintillation” effect. It should be understood that the series of logical ones shifted preferably have a low probability density function of about 1-10%. Therefore, at a given AND gate 515 an uncorrelated probability of 10% for each shift register translates into a 1% mutation rate.

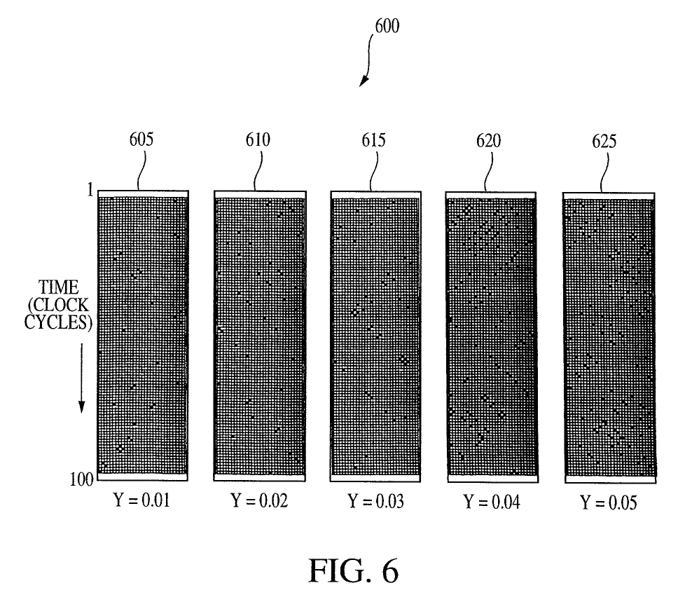

With reference now to FIG. 6 of the Drawings, there is illustrated the effect of varying the aforementioned mutation threshold value Tₘ on the mutation template, generally designated by the reference numeral 600. For example, each bit in the 30-bit chromosome in this embodiment is subjected to an increasing degree of mutation, e.g., by manipulating the mutation threshold value Tₘ. At left, in sample 605, after 100 time steps only a small number of discrete bits have mutated with the mutation factor (y) at a relatively low setting. As the value of the mutation factor is increased in samples 610-625, the number of mutated bits on a given chromosome increases commensurately.

With reference again to the mutation module 500 in FIG. 5, the output of the absolute value comparator 540 is inputted sequentially to the first shift register 530. As indicated by the rightward facing arrow, the first shift register 530 shifts the absolute value comparator 540 output bit-by-bit from left to right. A similar operation is performed by the aforementioned second absolute value comparator 545 and the corresponding second shift register 535, which, as indicated by the leftward facing arrow, shifts the second absolute value comparator 545 output bit-by-bit from right to left. Random numbers inputted to the absolute value comparators 540 and 545 preferably have no correlation, and therefore, bit stream patterns retained in the first and second shift registers 530 and 535, respectively, have no correlation.

As shown in FIG. 5, bits in the first and second shift registers 530 and 535 are connected to the n AND gates 515, with each gate's inputs connected to similar bit positions in each of the shift registers 530 and 535, e.g., bit 1 in each register connects to the first AND and bit n connects to the last AND. Each AND gate 515 thus inputs two bit values, logical ANDs the bits, and outputs a 1 only when the inputted bit values at the similar bit position in the shift registers 530 and 535 are both one. As further illustrated in FIG. 5, the second of the AND gates 515 from the left outputs a 1 when inputting dual ones at the second bit positions from the left in the respective shift registers 530 and 535, and so forth, as is well understood in the art. Outputs from the AND gates 515 together with outputs from the aforedescribed crossover module 300, i.e., the respective bits of the child chromosome 350 (C) in FIG. 3, are inputted to the n XOR gates 520, which performs an exclusive or of the respective bit positions of the child chromosome C, inserting a mutation at respective positions in the bit pattern of the child chromosome, when mutation is present. As is understood in the logic of this circuitry, when the output of a respective AND gate is one, the corresponding XOR gate inverts the respective child chromosome C bit, thereby inserting the mutation. Conversely, when the output of the AND gate is zero, the XOR gate outputs the value stored in the child chromosome, i.e., the XOR of dual zeroes is zero and that of a zero and a one is a one.

By virtue of the aforedescribed circuitry to implement chromosomal crossover and mutation, these facets of genetic algorithms are more accessible to modification, particularly dynamic modification. As discussed, prior techniques have focused on more static, albeit high-powered, methodologies for resolving intractable, hard-to-solve problems, such as the classic Traveling Salesman Problem. Through manipulation of some run-time variables, e.g., the degree and amount of crossover and mutation, a human observer of the evolving process could guide the evolution, perhaps more quickly to a better or alternate solution than merely running the program on fixed input variables. Indeed, with the human brain's innate complexity and the logical leaps of thought outside of the paradigms, humans could guide the algorithm toward a goal based on intuition or hunches. As with a grandmaster in chess, the mechanism to achieve a goal may be felt. Providing a tool to facilitate this approach is the focus of the instant application.

Employing a dynamic interface to solve the protein folding problem, as mentioned in the Background section, is a distinct improvement over the known art and illustrates the usefulness of the system and methodology of the present invention. As is well understood in the art, the protein folding problem attempts to find a minimal energy protein configuration, i.e., a complicated three-dimensional folding of a coiled string of protein molecules, where some molecules or residues of the protein are hydrophobic and some are hydrophilic. As is also understood in the art, the application of a genetic algorithm to discover the minimum-energy conformation for a lattice-constrained protein is a computationally challenging problem beyond the capabilities of any computer system, i.e., the problem is NP-hard. For ease of illustration, a two-dimensional version of the problem is employed to simplify the tertiary and quaternary complexities of protein folding.

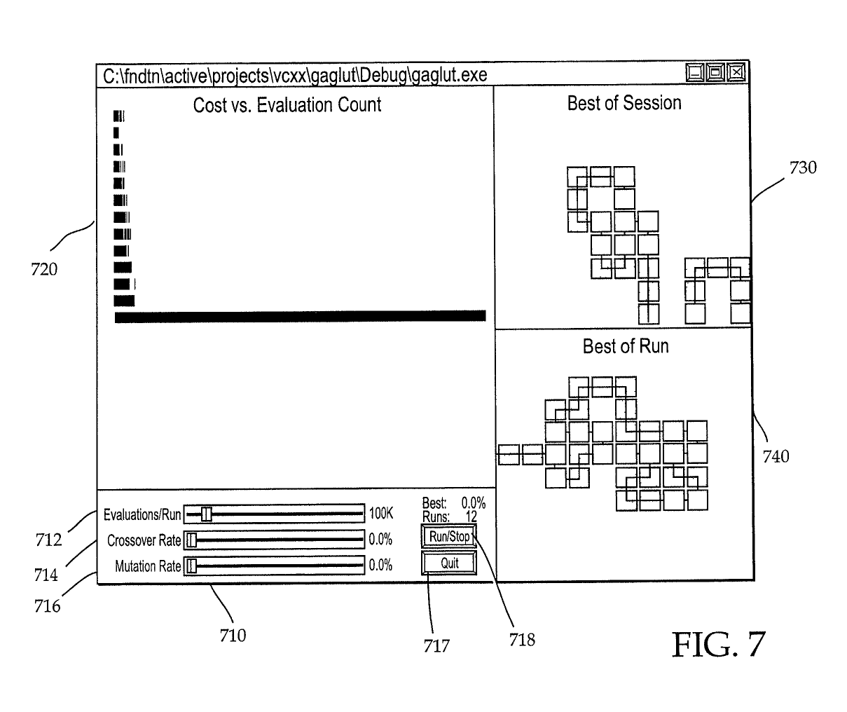

With reference now to FIGS. 7-12, there are illustrated various specific effects of varying three input parameters, such as those described above. Shown in FIGS. 7-12 are examples of a presently preferred visual interface for implementing the dynamic manipulation aspects of the present invention.

With reference now to FIG. 7, there is illustrated therein a representative graphical user interface in accordance with the present invention, generally designated by the reference numeral 700. As shown, interface 700 includes a number of discrete panels such as a control panel 710 for controlling various evolutionary parameters for the problem at hand, along with a slider to implement an adjustable variable. For example, control panel 710 includes an evaluations per run parameter slider 712, which determines the length of each run, i.e., how long the population has to evolve a solution. By manipulating the slider 712, this time period is freely adjustable. It should be well understood that the slider 712 may be selected and slid via a mouse or other such software tool. Alternatively, the variable may be manipulated by a knob, joystick, touchpad, or other device. Similarly, a crossover rate slider 714 permits the user to dynamically adjust the cutpoint probability, and a mutation rate slider 716 easily allows modification of the mutation probability. As illustrated, the control panel 710 also includes a quit button 717 and a run/stop button 718, along with indicia regarding the state or degree of matching and a run counter, generally disposed above said button 718, as illustrated.

The interface 700 further includes a cost versus evaluation panel 720, a graph which visually illustrates the pace of the evolution of the genetic algorithm in question to a good solution. A best of session panel 730 illustrates the best solution to the problem generated transfer in the session, and a best of run panel 740 illustrates the best configuration in that run. Each session is composed of a group of runs.

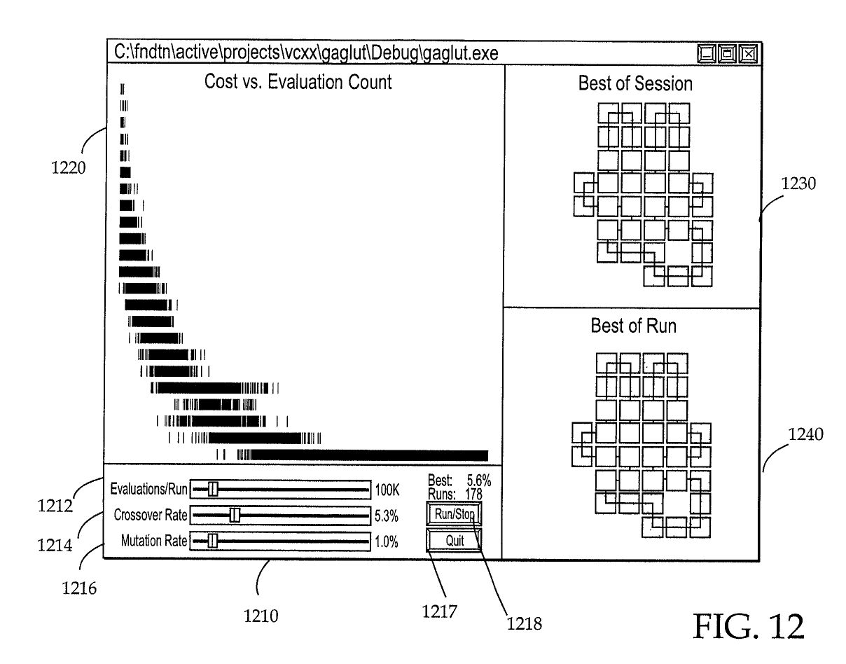

As will be illustrated further in the exemplary evaluations that follow, a human user, by manipulating the parameters, particularly the crossover rate slider 714 and the mutation rate slider 716, may “tune in” to a good solution by using human intuition as well as machine computation. Finding the optimal parameter configuration allows the GA machine to evolve a best solution. Altering the parameters also allows the user to control the cost vs. evaluation curve in the evaluations panel 720, which shows how quickly the GA machine evolves a good solution. As illustrated in FIG. 12, an ideal cost vs. evaluation curve shows an efficient evolution of a lowest-cost solution with a low amount of “noise” in the curve, as will be discussed in more detail herein below. It should be understood that the displays set forth in FIGS. 7-12 are what the user actually sees, i.e., the screen updates at 15 times or more a second and high computation rate makes the evolution appear as a continuous and quick process. In other words, the evolution process starts at the top (highest cost) and runs evaluations therefrom. When the evaluation run count (slider 712) is exceeded, another run is performed with the best solutions from the higher runs, i.e., at a lower cost.

With reference again to FIG. 7, a run with a first setting of the various aforementioned evolutionary parameters is illustrated. In particular, both the crossover rate slider 714 and the mutation rate slider 716 are zero percent, indicating that the only evolution occurring in this scenario is that two parent chromosomes are selected at random from the general population. Since no crossover occurs, one parent chromosome is selected to be the child and is copied directly as a child chromosome, as discussed hereinabove. The child chromosome is evaluated; if it is better, i.e., has a lower cost, than the parent chromosome not chosen, then the child chromosome, which is actually the chosen parent chromosome, replaces the parent chromosome not chosen in the population memory. This replacement process occurs until all parent chromosomes in the population memory have the same cost value with no genetic diversity and no good solution is found. The deficiency of these parameters can be seen in the flat curve of the cost vs. evaluation panel 720 and the dissimilar solutions evolved by the GA machine. In comparison to the aforementioned ideal solution, illustrated and described in connection with FIG. 12, the cost factor in this analysis terminates at a much higher point than the optimal solution, i.e., the cost decreases the further down the panel the analysis extents and the potential solution evolved in FIG. 7 is poor. As shown in the panel 720, the curve flattens at a high cost, showing that that parameter setting does not allow the evolution of a good solution.

In the analysis illustrated in FIG. 7, the incorrectness of the evolution parameters may be immediately evaluated by the user. By analyzing both the cost vs. evaluation curve in the panel 720 and the displayed solutions in panels 730 and 740, the user may adjust the parameters to bring the parameter settings closer to optimal and to increase the efficiency of the GA machine. The user, so armed with the failure of a solution, may then adjust the parameters in real time so that the user does not have to wait for the machine to continue the evolution of a solution with incorrect parameters, immediately and better directing to a better evolution of a solution.

For the protein folding problem (and indeed any intractable defined problem), the user preferably manipulates the crossover rate and the mutation rate to achieve more optimal parameter settings. For illustration purposes, the parameters will be changed separately and independently.

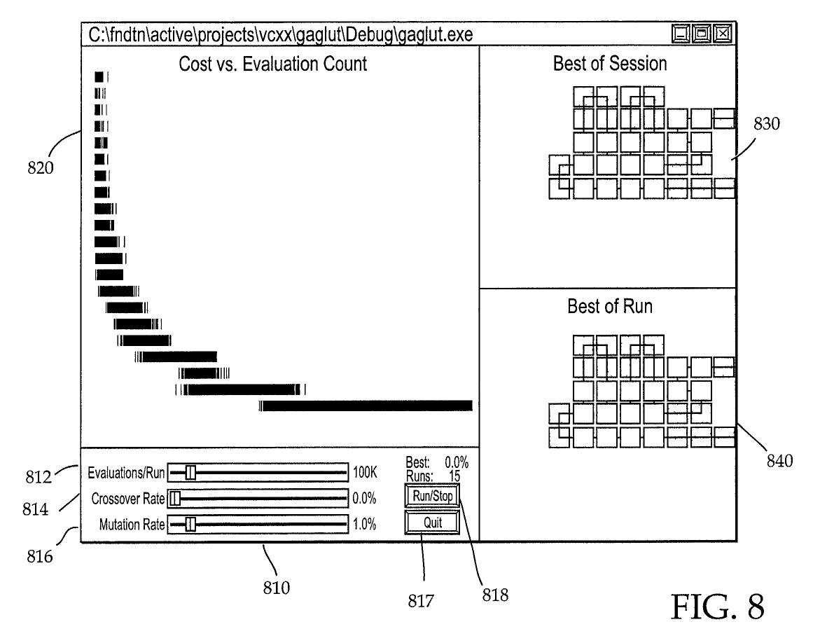

With reference now FIG. 8, a crossover rate slider 814 is still set to 0% and a mutation rate slider 816 is changed to approximately 1%, i.e., introducing a small degree of mutation into the mix. As with the example set forth in FIG. 7, this approach is essentially implementing a random search and, like the previous case, does not find a good solution. The addition of mutation, in this case, however, even at a small degree, does allow for a better solution than in the previous case. In particular, the cost vs. evaluation count curve in panel 820 reaches a low cost before flattening, and utilizes more evaluations per run to reach the lower cost.

In this case, the user may immediately evaluate the accuracy of the parameter settings. Although the parameter settings of this case allow a lower cost solution than the settings of the case of FIG. 7, the GA machine is nonetheless unable to evolve a best solution. Therefore, more adjustment of the evolution parameters is required by the user. Because the adjustments may be made during real time, the evolution of a solution may continue without significant delay, e.g., by merely using a mouse to move a slider control.

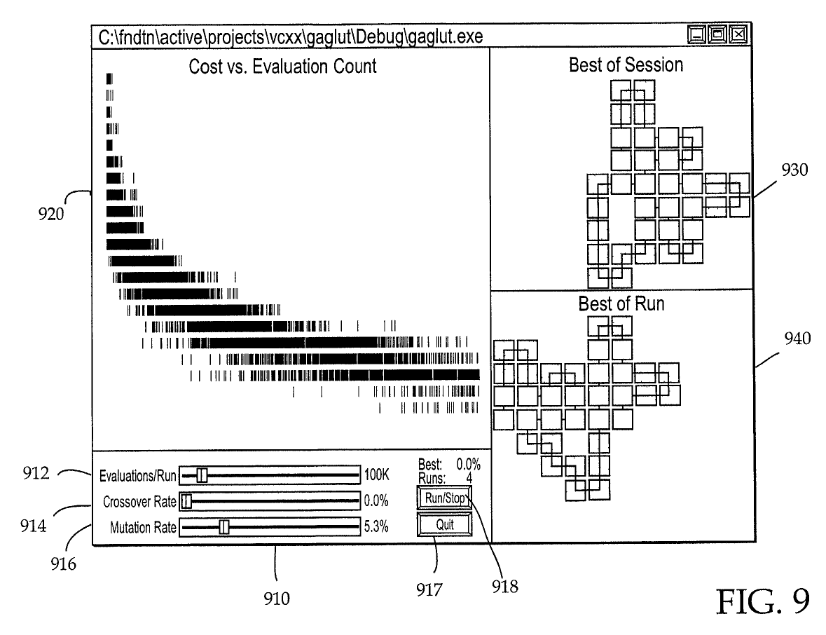

With reference now to FIG. 9, a crossover rate slider 914 is still set to 0% and a mutation rate slider 916 is set to approximately 5%, introducing a much larger measure of mutation into the general chromosomal population. The increased mutation rate in this case, however, degrades the efficiency of the cost vs. evaluation curve in panel 920 and increases the cost of the lowest-cost solution found from those found in the case illustrated in FIG. 8. Additionally, too much noise is added to the random search.

In this case, the accuracy of the parameter settings may be readily analyzed by the user and may be immediately seen as an improvement over the parameter settings of the first case, illustrated by FIG. 7, but as less optimal than the settings of the second case, illustrated by FIG. 8. More adjustment of the evolution parameters is, therefore, required by the user. Because the adjustments may be made dynamically or in real time, the evolution of a solution continues without significant delay.

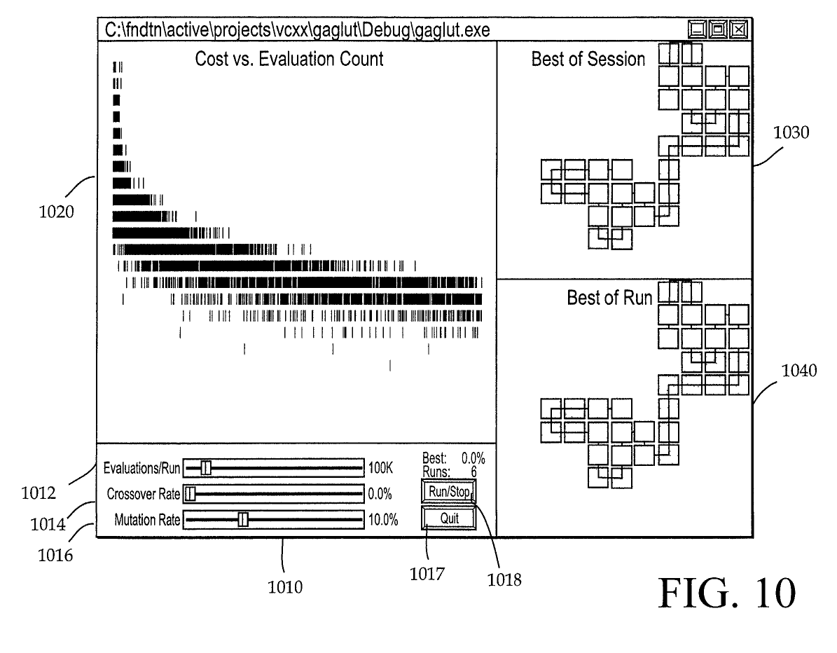

As illustrated in FIG. 10, a crossover rate slider 1014 in this example, is still set to 0% and a mutation rate slider 1016 is changed to 10%, introducing a still higher measure of random mutation. As can be seen in the cost vs. evaluation curve in panel 1020, with these parameters there is too much noise, and the curve reaches its lowest cost at the maximum number of evaluations per run. It is readily apparent that the best solutions found in this scenario have a higher cost than those found in the case illustrated by FIG. 9, and higher still than the solutions found in the case illustrated by FIG. 8.

In this case, the accuracy of the parameter settings may be analyzed by the user and may be immediately seen as less optimal than the settings of the second and third cases illustrated by FIG. 8 and FIG. 9, respectively, but an improvement over the parameter settings of the first case illustrated by FIG. 7. More adjustment of the evolution parameters is, therefore, required by the user.

The effects of the mutation rate are illustrated in FIGS. 7-10, where the examples demonstrate the bounds of the parameter required for the evolution of a solution. Of the four cases, the case illustrated in FIG. 8 is the closest to optimal, with an optimally set mutation rate of approximately 1%. It should be apparent that after the user determines the parameter bounds of the mutation rate, the user may then adjust the other evolution parameters to achieve the optimal parameter settings. In this case, than other evolution parameter is the crossover rate modifiable via the crossover rate slider.

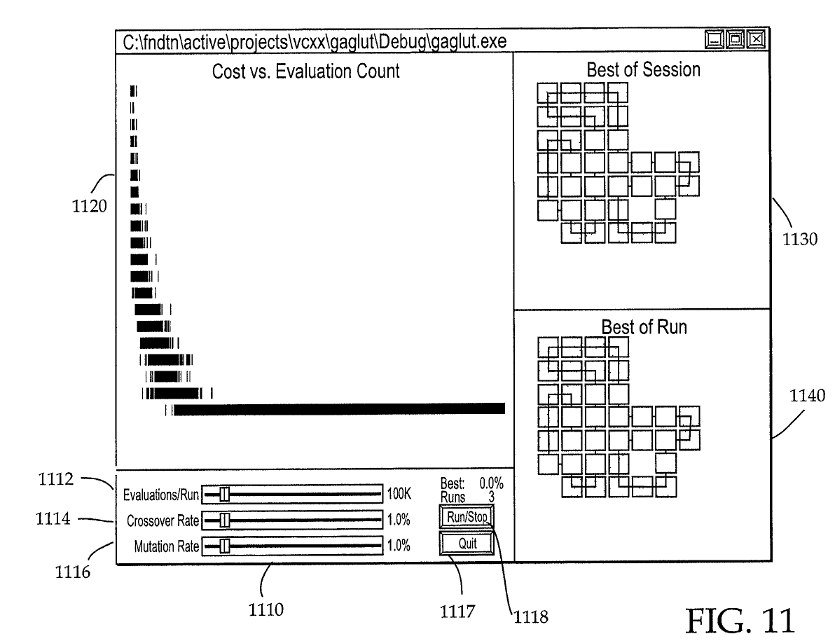

As illustrated in FIG. 11, a crossover rate slider 1114 is set to 1%, while a mutation rate slider 1116 is also set to 1%. In this case, more functionality of the GA machine is used. As is readily apparent, adding crossover to mutation results in more genetic diversity and in rapid convergence of the cost vs. evaluation count towards a good solution. The curve in panel 1120 flattens at a low cost and reaches that low cost in a small number of evaluations. Indeed, the solutions of this case have a lower cost than each case presented previously, except the case illustrated in FIG. 8.

In this case, the user may immediately evaluate the evolution parameter settings. The parameters are closer to optimal than those of the previous cases but do not yet evolve a best solution. The parameters allow the evolution a solution with a low cost, lower than the costs of solutions evolved with the parameter settings as illustrated in FIGS. 7, 9, and 10. However, the parameter settings illustrated by FIG. 8 allow for the evolution of a lower cost solution than that evolved with the current parameter settings. More adjustment of the evolution parameters by the user will, therefore, yield a better solution to the protein folding problem.

As illustrated in FIG. 12, a crossover rate slider 1214 is set approximately to 5% and a mutation rate slider 1216 is set to 1%. The cost vs. evaluation curve in panel 1220 is close to ideal in this case, with a rapid convergence to a best and lowest-cost solution. As illustrated, the curve in panel 1220 flattens at a low cost in a relatively small number of evaluations. Indeed, the curve here reaches a lower cost solution than any of the other cases presented above. In this case, more or less optimal settings allow rapid convergence to a best solution.

In this case, the usefulness of the GA machine and interactiveness of the advances of the present invention are illustrated. The user interface that gives the user direct adjustment of certain evolution parameters of the GA machine allows the user to “tune in” to the optimal evolution parameters for an efficient evolution of a best solution. Rather than rewriting and recompiling software code to manipulate the evolution parameters, or reconfiguring hardware, the user interface allows the user to easily make modifications.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

What is claimed is:

1. A graphical user interface displaying in a first portion thereof an evolution of a solution for a genetic algorithm, said graphical user interface comprising:
an evolution parameter field in a second portion of said graphical user interface, said evolution parameter field having a first position, said evolution parameter field comprising at least one variable related to the evolution of said genetic algorithm; and
modification means for modifying the evolution of said solution for said genetic algorithm in real time based upon a positional adjustment of said evolution parameter field from said first position to a second position.

2. The graphical user interface according to claim 1, wherein said evolution parameter field is a slider.

3. The graphical user interface according to claim 1, wherein said evolution parameter field is manipulated by a mouse, joystick, knob, or touchpad.

4. The graphical user interface according to claim 1, wherein said variable related to the evolution of said genetic algorithm is a number of evaluations performed in said genetic algorithm.

5. The graphical user interface according to claim 1, wherein said variable related to the evolution of said genetic algorithm is a probability of any bit in a chromosome being a cutpoint in said genetic algorithm.

6. The graphical user interface according to claim 1, wherein said variable related to the evolution of said genetic algorithm is a probability of any bit in a chromosome being mutated in said genetic algorithm.

7. The graphical user interface according to claim 1, wherein said modification means comprises a direct manipulation of said genetic algorithm as indicated by the positional adjustment of said evolution parameter field, said direct manipulation being accomplished by overwriting a variable used in said genetic algorithm.

8. A method for dynamically modifying an evolution of a solution for a genetic algorithm, said method comprising steps of:
adjusting an evolution parameter field within a graphical user interface of a computer system from a first position to a second position, resulting in a positional adjustment, said evolution parameter field comprising at least one variable related to the evolution of said genetic algorithm;
updating the evolution of said solution for said genetic algorithm in real time based upon said positional adjustment in said step of adjusting; and
displaying the update of said solution for said genetic algorithm within the graphical user interface.

9. The method according to claim 8, wherein in said step of adjusting, said evolution parameter field is adjusted from said first position to said second position by a user.

10. The method according to claim 8, wherein said step of updating comprises a direct manipulation of said genetic algorithm as indicated by the positional adjustment of said evolution parameter field, said direct manipulation being accomplished by overwriting a variable used in said genetic algorithm.

11. The method according to claim 10, wherein said variable used in said genetic algorithm is a number of evaluations performed in said genetic algorithm.

12. The method according to claim 10, wherein said variable used in said genetic algorithm is a probability of any bit in any solution being a cutpoint in said genetic algorithm.

13. The method according to claim 10, wherein said variable used in said genetic algorithm is a probability of any bit in any solution being mutated in said genetic algorithm.

14. A machine readable memory for storing computer code to act as a graphical user interface to a genetic algorithm, said memory comprising:
a first code section stored in memory for receiving an adjustment of an evolution parameter field within said graphical user interface from a first position to a second position, resulting in a positional adjustment, said evolution parameter field comprising at least one variable related to the evolution of said genetic algorithm;
a second code section stored in memory for updating the evolution of said solution for said genetic algorithm in real time based upon said positional adjustment in said step of adjusting; and
a third code section stored in memory for displaying the update of said solution for said genetic algorithm within the graphical user interface.

15. The machine readable memory according to claim 14, wherein said memory exists on a server.

16. The machine readable memory according to claim 14, wherein said memory exists on a website.
